(19) United States
(12) Patent Application Publication
(10) Pub. No.: US 2025/0217757 A1
(43) Pub. Date: Jul. 3, 2025

(54) Method and System for Product Waste and/or Carbon Reduction in Retail Channels of Trade

(71) Applicant: InnoVision Headwear Inc., Markham (CA)

(72) Inventors: HO TUNG AU-YEUNG, MARKHAM (CA); DAVID ARCHER, TORONTO (CA); MARIA ELINA NURKKA, TORONTO (CA); NORMAN HO YEE AU-YEUNG, TORONTO (CA)

(21) Appl. No.: 19/087,868

(22) Filed: Mar. 24, 2025

Related U.S. Application Data
(63) Continuation of application No. PCT/CA2023/051275, filed on Sep. 27, 2023.
(60) Provisional application No. 63/410,369, filed on Sep. 27, 2022.

(51) Int. Cl. G06Q 10/0837; G06Q 30/0601

(52) U.S. Cl. CPC G06Q 10/0837; G06Q 30/0641

(57) ABSTRACT

A method and system presents a returns marketplace for conducting e-commerce transactions to resell return items. An interface stores a listing for a return item purchased from a merchant by buyer A and presents the listing to buyer B in response to the relative buyer locations. Delivery to buyer B from buyer A is arranged following a concluded resale transaction. The delivery avoids a delivery from buyer A to a return location of the merchant to reduce an overall environmental impact associated with product returns. The buyer B delivery may avoid any of: repackaging of the return item for resale; restocking of the return item for resale; destruction of the return item; and may achieve carbon emission savings. The carbon emission savings can be calculated and presented to entice a purchase. Resales can be time limited to prompt quick resale and facilitate prompt return of unsold items to the merchant.

### CROSS-REFERENCE

This application is a continuation of PCT/CA2023/051275 filed Sep. 27, 2023, which is incorporated herein by reference in its entirety. The PCT application claims priority to or a domestic benefit of U.S. Provisional Patent Application No. 63/410,369, filed Sep. 27, 2022, which is incorporated herein by reference in its entirety.

### FIELD OF INVENTION

This application relates to green technologies and more particularly to a method and system for product waste and/or carbon reduction in retail channels of trade.

### BACKGROUND

The rise of online retailing is well-documented. The U.S. Census Bureau of the Department of Commerce announced May 19, 2022 that the estimate of U.S. retail e-commerce adjusted sales for the first quarter of 2022, was $250.0 billion, an increase of 2.4 percent (±0.7%) from the fourth quarter of 2021. Yet barriers to adoption exist. The online purchase experience is framed by many factors, one of which is product returns. Product returns are a persistent issue for buyers, merchants and product originators. Too often, purchased products do not meet a buyer's needs and are returned, through the merchant or a return service on the merchant's behalf. The costs associated with returns are high. Costs include shipping, repackaging, restocking, and others. Disposal of returned product is used to minimize return costs.

Shipping costs are not just monetary but are also environmental. One such measure of environmental cost is the amount of CO₂ emitted per kilometre. Typical measures also include other greenhouse gases along with CO₂. Product waste, whether the product itself and/or its packaging contributes, to environmental costs through loss of raw materials, energy spent for production and shipping, etc.

Merchants and their buyers are looking for sustainable practices that provide real-world improvements and benefits. Reduction of product waste and carbon emissions can be real-world tangible outcomes.

### SUMMARY

A method and system presents a returns marketplace (which may be a returns resale function integrated with a merchant's online sales platform or separate therefrom) for conducting e-commerce transactions to resell return items. An interface stores a listing for a return item purchased from a merchant by buyer A and presents the listing to buyer B in response to the relative buyer locations. Delivery to buyer B from buyer A is arranged following a concluded resale transaction. The delivery avoids a delivery from buyer A to a return location of the merchant to reduce an overall environmental impact associated with product returns. The buyer B delivery may avoid any of: repackaging of the return item for resale; restocking of the return item for resale; destruction of the return item; and may achieve carbon emission savings. The carbon emission savings can be calculated and presented to entice a purchase. Resales can be time limited to prompt quick resale and facilitate prompt return of unsold items to the merchant.

### BRIEF DESCRIPTION OF DRAWINGS

FIGS. 1A and 1B show delivery scenarios for product items in accordance with embodiments.

FIGS. 2A and 2B are flowcharts of operations in accordance with embodiments.

FIG. 3 is a diagram of a computing environment in which aspects herein may be practiced, in accordance with an embodiment.

FIGS. 4A-4E are flowcharts of operations in accordance with embodiments.

FIGS. 5, 6, 7, 8, 9A, 9B, 9C, 10A, 10B, 11A, 11B, 11C, 11D, 12A, 12B, 12C and 12D are screen shots of user interfaces in accordance with respective embodiments.

### DETAILED DESCRIPTION

The description and/or drawings herein may make reference to a trademark DEBRANDIFY of Debrandify Inc. All rights in and to each trademark are reserved.

As used herein, an online buyer is a person who has purchased and received delivery of a product through an e-commerce transaction—a transaction conducted online using a computing device. The product comprises a physical good that was shipped to the online buyer, or another person on behalf of the online buyer. This is contrasted with a traditional buyer who has purchased a product comprising a physical good through a traditional source such as a physical store (e.g. a bricks-and-mortar store). While most traditional purchases include a transfer of possession of the purchased product at the store at the time of concluding the purchase transaction, some products are delivered later such as to an address of the purchaser's choosing. A merchant is a seller of the physical good to the buyer, whether on-line or traditional. An-online merchant sells online via e-commerce and a traditional merchant via a traditional channel such as a physical store. A merchant may have both online and traditional channels in its business model. A product originator is an entity that has first made the product available and is typically the brand owner associated with the product. Product originators may sell directly to purchasers (e.g. as a merchant) and/or may sell via one or more merchants.

Buyers and merchants each have respective associations to one or more geographic locations. For example, an online buyer is associated with the shipping address to which product was delivered. A merchant is associated with a shipping address from which the shipment to the online buyer originated. A merchant may have one or more warehouses, physical stores, third party fulfillment location or other locations from which the product is shipped to fulfill an online order or to receive a return item purchased by an online buyer.

Some merchants (whether online merchants or traditional merchants), employ a third party (independent) service for product return handling. In such a case, the merchant is associated with the third party shipping address or addresses where returned products are shipped.

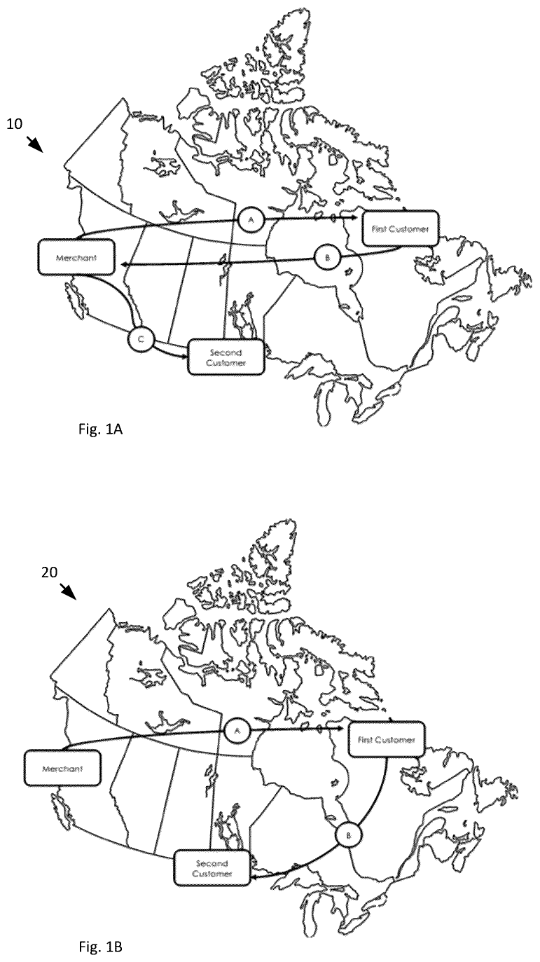

When an online buyer desires to return a product, there is often a requirement to engage in an online transaction to fill in a return request and obtain a shipping label. In some instances, the return is less automated and at the burden of the buyer. In any event, the return product is shipped to a return location associated with the online merchant. Often this distance is relatively large, for example, over a 1,000 km (600 miles). Shipments can also cross international borders. FIG. 1A shows a representative purchase A to a first customer, a return B to a merchant and a resale C from the merchant to a second customer indicating a journey 10.

An object of the method and systems herein seeks to reduce product waste and/or carbon emissions by providing an alternative return environment to buyers, merchants and others.

There is provided a returns-based marketplace in which online buyers and merchants participate to re-sell returned products. FIG. 1B shows a representative purchase A to a first customer, and return B to a second customer indicating a journey 20 and in which an instance of shipping is removed, reducing a total distance shipped. In an embodiment, the marketplace provides services and features to incentivise returns via the marketplace to achieve greater reduction of product waste and/or carbon emissions.

The returns marketplace platform, which can be a branded DEBRANDIFY marketplace by the applicant herein as noted, comprises an e-commerce platform for products that are being returned (product returns). In an embodiment, a respective merchant signs up to receive services from the marketplace platform. The return service, in an embodiment, is integrated into the merchant's product return process. For example, the marketplace platform is integrated into the merchant's website. Product returns are sold on a returns marketplace platform via its website or via an application, for example.

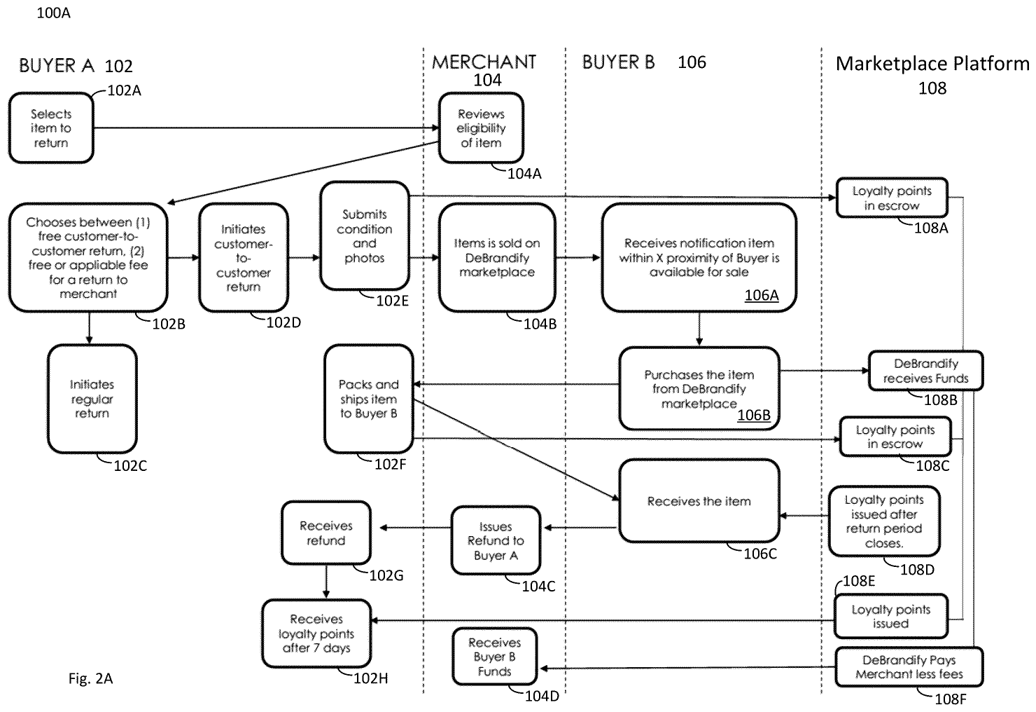

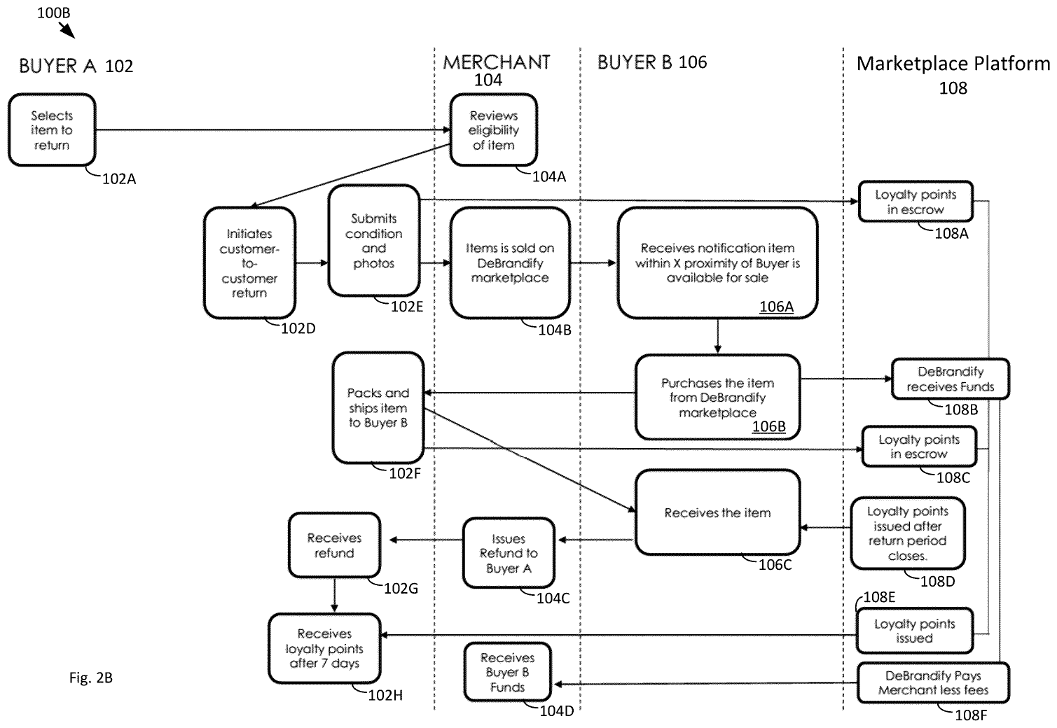

FIGS. 2A and 2B are flowcharts of operations 100A and 100B in accordance with respective embodiments each providing an overview of a product return via the marketplace. Operations 100A and 100B relate to those of a first on-line buyer (buyer A 102) who desires to return the product (e.g. a returned product), a merchant 104 who sold the product originally and who provides a return option via the marketplace, a second on-line buyer (buyer B 106) who desires to participate in the marketplace platform and purchase a returned product, and the marketplace platform itself 108. It will be apparent that many of the specific operations in FIGS. 2A and 2B are performed via respective computing devices (not shown) operated by or on behalf of buyer A (e.g. performing at least some of operations 102A-102H), merchant (e.g. performing at least some of operations 104A-104D), buyer B (e.g. performing operations 106A-106C) and the marketplace platform (e.g. performing at least some of operations 108A-108F). Buyer A and buyer B can operate personal devices such as a smartphone, tablet, laptop or other computing device. Merchant and marketplace platform related computing devices comprise components of an e-commerce platform and typically comprise servers and other devices providing a database, web-based interfaces (e.g. e-commerce website), and the like to buyers and other participants in the marketplace, as described further. In an embodiment, such components comprise merchant components of an existing online retail platform and additional components of the marketplace platform as disclosed herein. Alternatively or in addition to a web-based interface for buyers to interact via web browser applications, the platform can be offered to buyers via an application such a native application for execution via the buyers' smartphones/tablets or similar devices. References to web-interfaces or website or similar components herein includes, where the context permits, interfaces for native applications.

Operations 100A are distinguished from 100B in that only returns via the marketplace are permitted in operations 100B. Regarding FIG. 2A, initially buyer A selects a product to return. Eligibility of the selection is performed for the merchant, such as using business rules of the merchant (not shown). If eligible for return, the buyer can select between a regular return or return via the marketplace. Regular return operations are not shown further.

The remainder of FIG. 2A is the same as FIG. 2B. The marketplace platform provides a customer-to-customer return scenario where the return product is offered for second sale via the marketplace platform. Buyer A participates such as by submitting photos and product condition information. Buyer A can earn loyalty points from the marketplace platform for performing certain activities such as submitting photos. The return product is listed on the marketplace—e.g. a product entry for the specific instance of the product is created in the database automatically, and in an embodiment, includes merchant information for the product as obtained from a merchant product database. In an embodiment, the marketplace platform is configured to operate for a single merchant, segregating merchant information and their customer's information in separate components from those of other merchants and their customers. In another embodiment, the marketplace database(s) and the marketplace platform provide services for more than one merchant.

Buyer B receives notification of the availability of the product. Notification can be via a subscription for such notices or by browsing/conducting a search via buyer B's computing device, etc.

In an embodiment, notification is responsive to physical proximity between buyer A and buyer B. In an embodiment, buyer B gives permission to use location information from buyer B's computing device, for example, global positioning satellite (GPS) information. In an embodiment, buyer B can have a profile (not shown) with location information. Or, in an embodiment, buyer B can search for product instances that are within a defined distance (e.g. a radius or other measure of distance). In an embodiment, the defined distance can be responsive to carbon emission cost of transport and/or mode of shipping to buyer B. For example, the number of grams of carbon emission per km traveled is known for different types of transportation. Buyer B can input a distance that is responsive to carbon emission cost such as a maximum number of grams of carbon to be emitted for shipping to buyer B, e.g. shipping mode or modes of transport are not to exceed the number of grams. A data store (e.g. a database) of shipping information with carbon emission costs can be prepared and data extracted to determine a maximum distance for buyer B responsive to the input. The data can be further analyzed to filter for shipping services that can meet the distance.

Buyer B purchases the returned product via the marketplace platform—engaging in an e-commerce transaction. The marketplace platform can receive the purchase funds for the return, for providing to the merchant, less an applicable fee or fees. For example, the platform can deduct from purchase amounts received, shipping and handling, commissions, and service fees. Notification is sent to buyer A. Buyer A packs and ships the product to buyer B, which activity can earn loyalty points credited to buyer A upon conclusion (e.g. at the end of the return period). Buyer A is provided with shipping information such as further described below. Buyer B receives the product and confirmation of its receipt, for example, through shipping tracking information is provided to the marketplace platform. Merchant issues a refund to buyer A and the refund is received. Buyer A (as a seller) receives loyalty points as shown and noted.

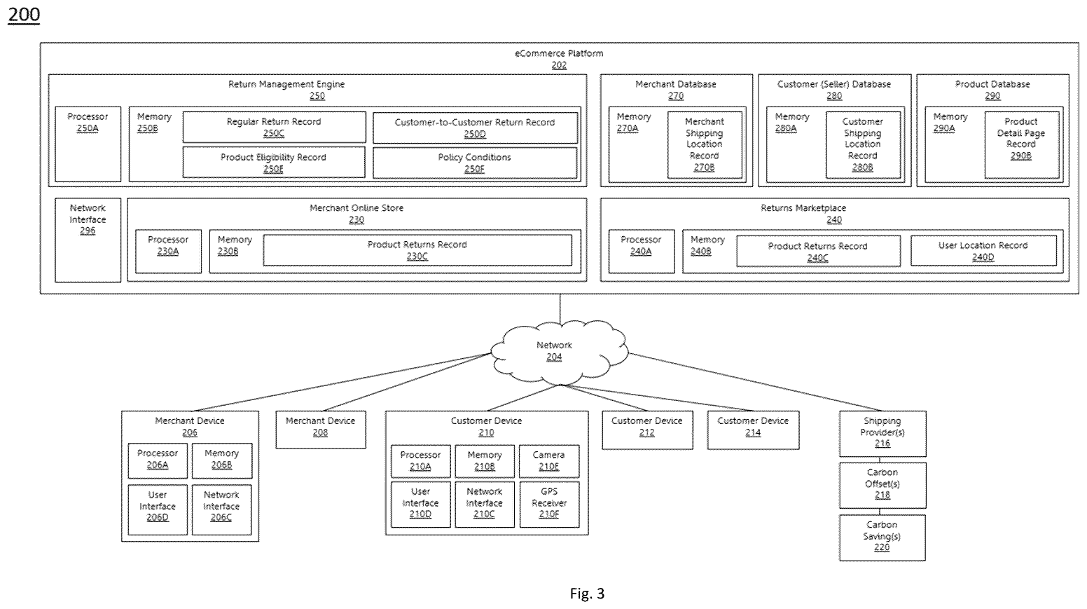

FIG. 3 is a block diagram of computing environment 200, in accordance with an embodiment. The diagram is a simplified environment for an e-commerce solution, as would be understood by a person of ordinary skill in the art. An e-commerce marketplace platform 202 (platform 202) is coupled via a communication network 204 to communicate with various client devices, such as merchant devices 206 and 208, customer devices 210, 212 and 214. Platform 202 is further coupled to communicate with service providers to platform 202, for example, shipping provider(s) 216. Shipping providers 216 can communicate with carbon offset(s) providers 218, and in turn carbon savings calculators 220. For example, a third-party application integration can calculate emissions from transportation in the checkout process, and purchase carbon offsets to offset the emissions generated by the transportation operations. Preferably, the same integrated application can calculate carbon savings (based on customer locations) and carbon offsets (in checkout process).

E-commerce platform 202 comprises an integrated platform presenting both a merchant online store 230 and a returns marketplace 240 (also an online store). E-commerce platform 202 further comprises a return management engine 250, a merchant database 270, a customer (e.g. a marketplace seller) database 280, and a product database 290. A representative network interface 296 is shown. Not shown in FIG. 3 for simplicity, is a payment gateway device such as for clearing e-commerce transactions.

Merchant device 206 is representative of other merchant devices. Merchant device 206 comprises a processor 206A, a storage device (e.g. memory) 206B, network interface 206C and a user interface 206D. In each of the respective computing devices, the storage device stores computer readable instruction that, when executed by the processor, cause the computer to perform operations such as described herein. User interface 206D comprises one or more of a display screen (which may be touch enabled (e.g. for gestural input)), keyboard, pointing device, speaker, microphone and other input, output or input/output devices. Merchant device can be operated by administrative users such as those responsible to operate and maintain the merchant online store and the merchant aspects of the return marketplace. Although environment 200 is configured for marketplace services for a single merchant, a merchant can have more than one device to communicate with the platform, including the merchant's online store components.

Customer device 210 comprises a processor 210A, a storage device (e.g. memory) 210B, network interface 210C and a user interface 210D. Customer device 210 further comprises (or is coupled to communicate with a camera 210E and a GPS receiver 210F providing location information. Customer device 210 is representative of devices 212 and 214. In an embodiment, customer devices 210, 212 and 214 are devices of buyer A, buyer B and Buyer C.

Devices 216, 218, 220, in an embodiment, are similar in hardware configuration to merchant device 206. Each of the respective computing devices herein can be configured for respective operations such as via software.

Merchant online store 230 comprises a processor 230A and a storage device (e.g. memory) 230B. A representative product returns record 230C is stored in memory 230B.

Returns marketplace 240 comprises a processor 240A and a storage device (e.g. memory) 240B. A representative product returns record 240C is stored in memory 240B A representative user location record 240D is stored in memory 240B.

Return management engine 250 comprises a processor 250A and a storage device (e.g. memory) 250B. Representative records are stored in in memory 250B, including regular return record 250C, customer-to-customer return record 250D, product eligibility record 250E and policy conditions 250F.

Merchant database 270 comprises a storage device (e.g. memory) 270A storing a representative merchant shipping location record 270B. Customer database 280 comprises a storage device (e.g. memory) 280A storing a representative customer shipping location record 280B. Product database 290 comprises a storage device (e.g. memory) 290A storing a representative product detail page record 290B.

In an embodiment, platform 202 can be configured to provide a returns marketplace for more than one merchant. Respective records for different merchants can be maintained in separate storage devices (e.g. respective merchant product databases, merchant location/shipping database, customer databases, etc.). Platform 202 can integrate with respective merchant online stores/returns interfaces. Selling customers such as buyer A can request returns from online orders of any participating merchant at platform 202. When engaging with the returns marketplace, buying customers such as buyer B or buyer C can be presented with returned product from any one or more of the participating merchants, for example, as selected for the buying customer. Merchant product data, order data, etc. for a returned item listing can be obtained by platform 202 from components of the respective merchant's online store (only one store is shown in 202). Each merchant can set their respective platform settings via interfaces of return management engine 250, similarly as shown and described.

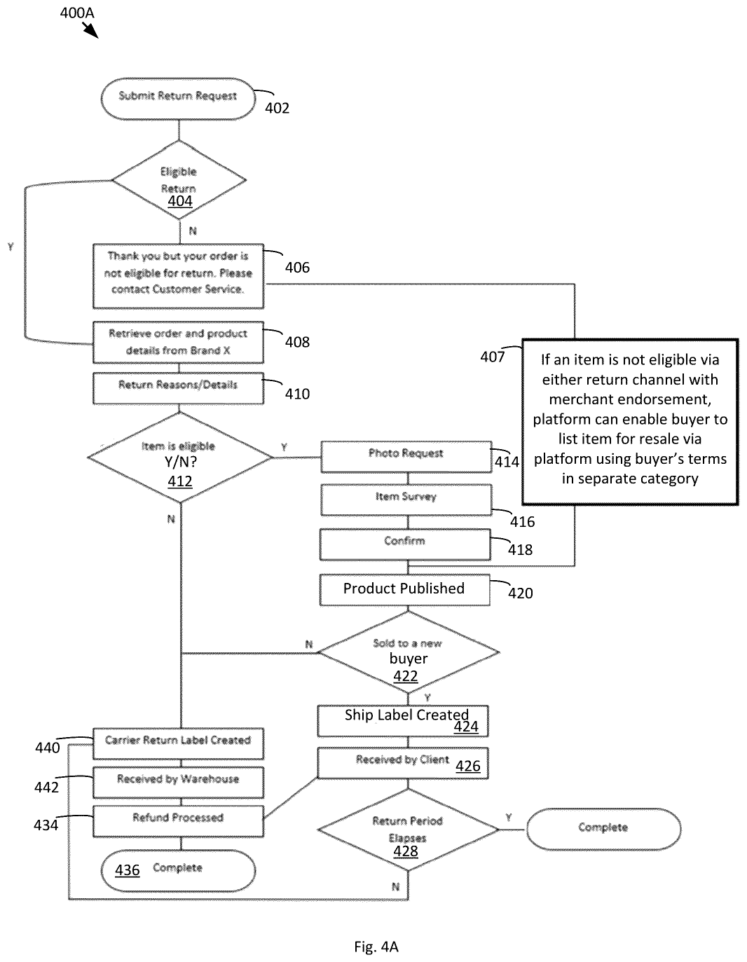

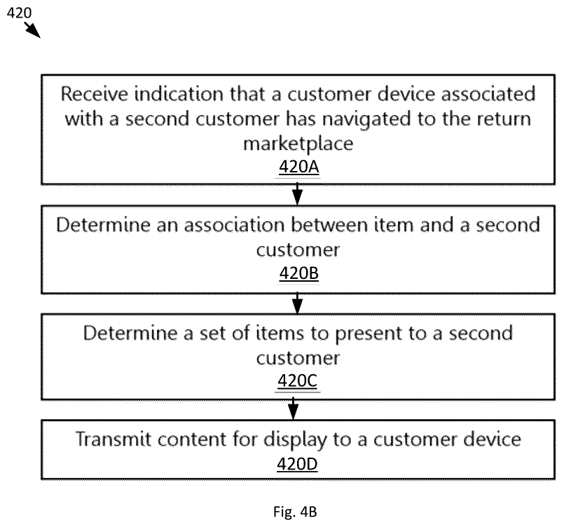

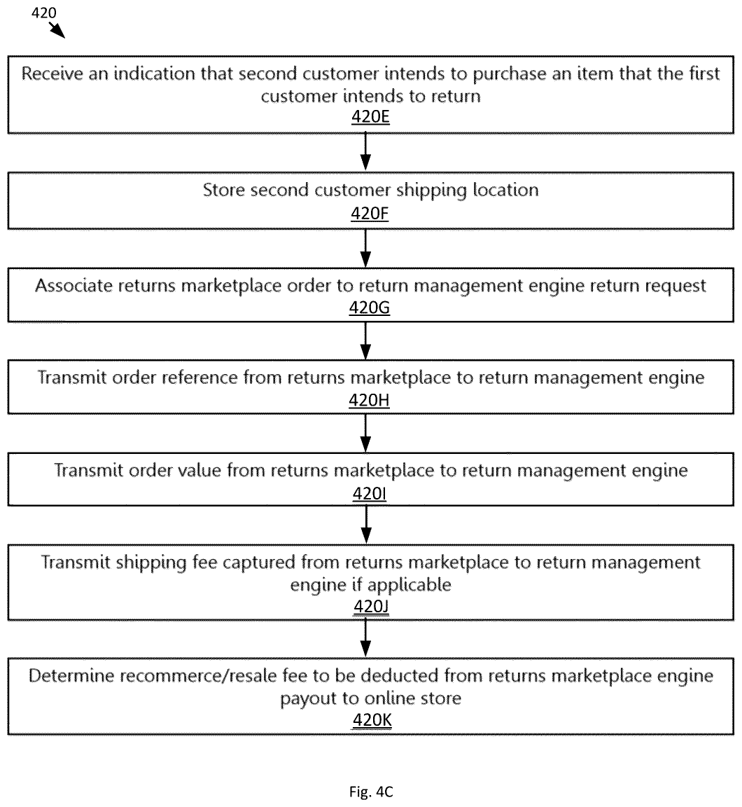

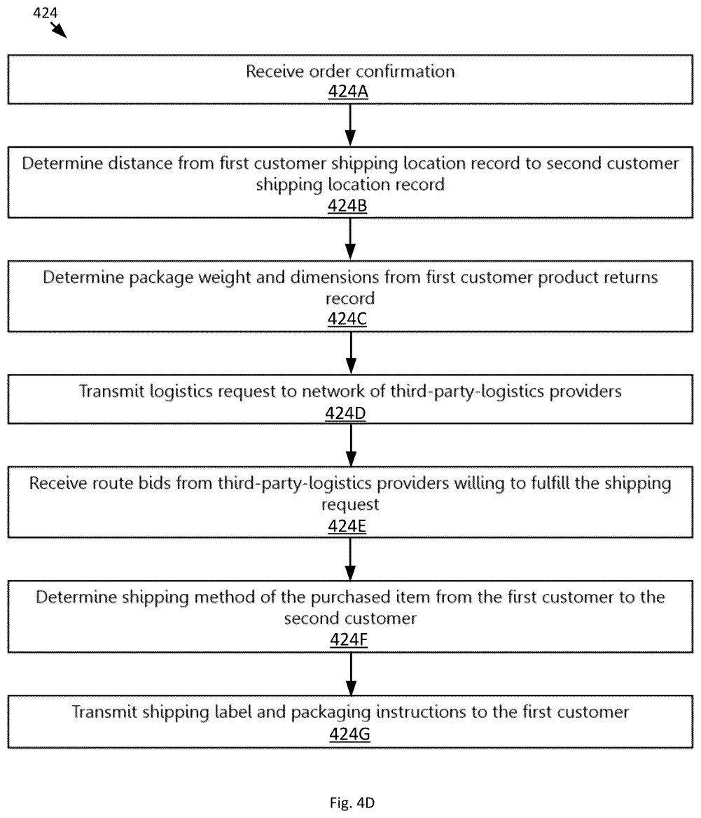

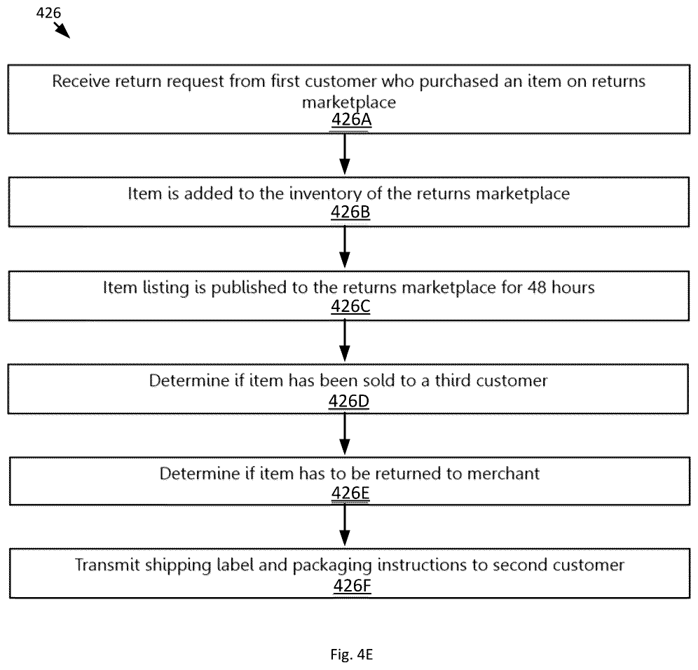

FIG. 4A is a flowchart showing an overview of operations 400A of platform 202 (e.g. merchant online store 230, return management engine 250, and returns marketplace 240) providing integrated return services to a customer (e.g. Buyer A), in accordance with an embodiment. FIG. 4A includes optional operations showing how ineligible merchant returns are handled.

After the online store 230 receives a return request (402), an eligible return is evaluated at 404. The request is evaluated against merchant criteria such as that the product condition meets a policy setting and it is not an item that is marked for refund exclusion. Each item is so evaluated.

If an order is not return eligible, customer can be directed to customer service at 406. Alternatively or in addition, in the embodiment of FIG. 4A, the customer can be directed to list the item with the returns marketplace (e.g. via the return engine) but not as an eligible return (e.g. via branch to 407).

If the return is initially eligible, at 408 the merchant online store 230 communicates order and product details to return management engine 250. At 410, return reasons and details are received and, at 412, it is determined whether the item is eligible for return via the returns marketplace 240. For example, each item is evaluated to determine whether a return reason qualifies for resale and if the item is marked for resale exclusion. If the product is eligible for the returns marketplace platform 240, operations automatically prepare a listing. The product listing will pull information (description, attributes, images, and original price) from the merchant's website based on the products listed on the customer's purchase order eligible for marketplace return. The product's price in the listing for second purchase will be reduced from the original retail price to incentivize the second customer to purchase a product directly from the original customer. As shown in FIG. 3, a customer shipping location is stored, a merchant shipping location record is stored, a product return record is stored. Operations 414, 416, and 418 obtain listing information and a confirmation to list from the customer (e.g. Buyer A). In an embodiment, the customer provides one or more photos, and completes an item survey. These activities can earn the customer loyalty/reward points and/or marketplace platform credit for spending on the marketplace platform, for example as an incentive to provide the information.

In an embodiment, the interface to be presented to a potential second customer includes information specific to the potential second customer (buyer B) and/or information that is responsive to the time of the presentation (e.g. to buyer B) while shopping at the returns marketplace 240. In an embodiment, when the product is listed (at 420) in a record for selling via returns marketplace 240, a count down timer for a re-sale is started from a maximum time, incentivising a quick sale. The maximum time may be 48 hours, for example. A timer relative to the maximum time and the time of the listing is presented in association with the product information. Further, in an embodiment, the product listing when presented to buyer B includes a geo-location element. Operations calculate a distance between buyer A and buyer B (or buyer B and Buyer C), buyer A (or buyer B) and merchant warehouse, and buyer B (or Buyer C) and merchant warehouse to estimate the carbon emission savings for shipping from buyer A to B (or B to C) instead of returning the product to the merchant's warehouse and shipping buyer B (or C) the product (or a new product). In the embodiment, the carbon emissions savings estimate is displayed on the product page to inform buyer B/C of the environmental benefits.

Further details for operations 420 are shown in FIGS. 4B and 4C comprising steps 420A-420K to present a listing to a potential customer (buyer B) and conduct a sale transaction. Aspects of a sale transaction are simplified but would be understood by a person of ordinary skill in the art. For example, payment aspects are not shown or described. When buyer B or C visits the returns marketplace website, the Buyer's geo-location is, for example, used to determine which products the customer can view on the website. A profile may determine location information. The products the potential buyer can view are limited to a specific radius based on their location. The radius could be, for example, 50 km, to address environmental impact.

Operations at 422 determine if a sale is concluded. If yes, at 424 a shipping label is a created for shipping the item to buyer B, where the label is communicated to buyer A, such as by email, to pack and ship the item. Operations at 424 are shown further in FIG. 4D. In a scenario where buyer A has multiple return items with a same return request, a shipping label or labels may be held until it is determined which items are shipping to one or more second customers, if any, and which items are returning to the merchant, if any. For example, buyer A's return request may also include products that are not eligible for the returns marketplace, in which case a separate return label will be provided to return these products back to the merchant. If an order contains both items returned back to merchant and items posted on the returns marketplace, all shipping labels are held until the closing of the sale window (e.g. 48 h 72 H, as applicable) and delivered to buyer A at the same time. Products posted on the returns marketplace but not sold are returned back to the merchant from buyer A. At either 412 or 422, operations branch to 430 as either the item is returnable but not returnable via returns marketplace 240 or no sale occurred via the marketplace 240 within the time limit. A carrier label is produced for buyer A to return to the merchant's return location (430) and confirmation of the return is received. At 434 a refund for buyer A is processed and operations conclude (436) in respect of this particular item. FIG. 4D is a flowchart of operations 424 where at 424A an order confirmation is received. At 424B, a distance from first customer shipping location record to second customer shipping location record is determined. At 424C, weight and dements from first customer product returns record is determined for the package. At 424D, a logistics request is transmitted to 3^{rd} party logistics providers. At 424E, route bids are received from providers willing to fulfill the shipping request. The shipping method is determined at 424F and label and instructions are sent to the first customer at 424G.

At 426, confirmation is received that buyer B has received the item. Buyer A receives a refund (at 434) when buyer B receives the item. Operations at 426 are shown further in FIG. 4E. Once buyer B has received the product, they may be offered loyalty points/marketplace credit for keeping the item to incentivize against returning the product (e.g., one point for every dollar spent). In an embodiment, buyer A is offered marketplace loyalty points/credit after the delivery to buyer B. In an embodiment, the points/credit depend on the rating of the receiving customer gives to buyer A based on product condition, shipping speed, and packaging condition. At 428, if buyer B is not satisfied with the product, they may return the product within the return period (e.g., 7 days). If the buyer B initiates a return within the return period, a carrier return label is created (430) and sent to buyer B (e.g., via email) and the product is shipped back to the merchant. Buyer B refund is processed at 434 after the confirmation of receipt at the merchant location/warehouse in 432. If the buyer B does not initiate the return within the return period, the process ends at which point buyer B may be credited loyalty points for the purchase (as shown in FIGS. 1A and 1B). Alternatively (not shown in FIG. 4A), buyer B can relist the product (request a return through the marketplace website) and will then go through the same process as with buyer A, starting at 402. Whether products can be relisted on the returns marketplace 240 by buyer B or are returned to merchant, can be determined by the merchant in the return management engine policy conditions 250F. FIG. 4E is a flowchart of operations 426. At step 426A, operations receive a return request from the first customer who purchased an item via the returns marketplace (the second customer overall). At 426B, the item is added to the inventory of the returns marketplace. At 426C, a listing of the item is published for 48 hours. At 426D, a determination is made whether the item is sold to a third customer. At 426E, operations determine if the item has to be returned to the merchant (e.g. because it was not sold). At 426F, a return label and shipping instructions are sent to the second customer to return the item.

As shown in FIG. 3, platform 200 uses 3rd party integrations to execute certain tasks: 1) shipping and shipping labels management; 2) calculation of shipping distances and carbon emissions related to shipping, shipping options based on shipping method and associated reduction in carbon emissions, carbon offsets from shipping, calculation of cumulative carbon savings from shipments; and 3) Carrier integrations.

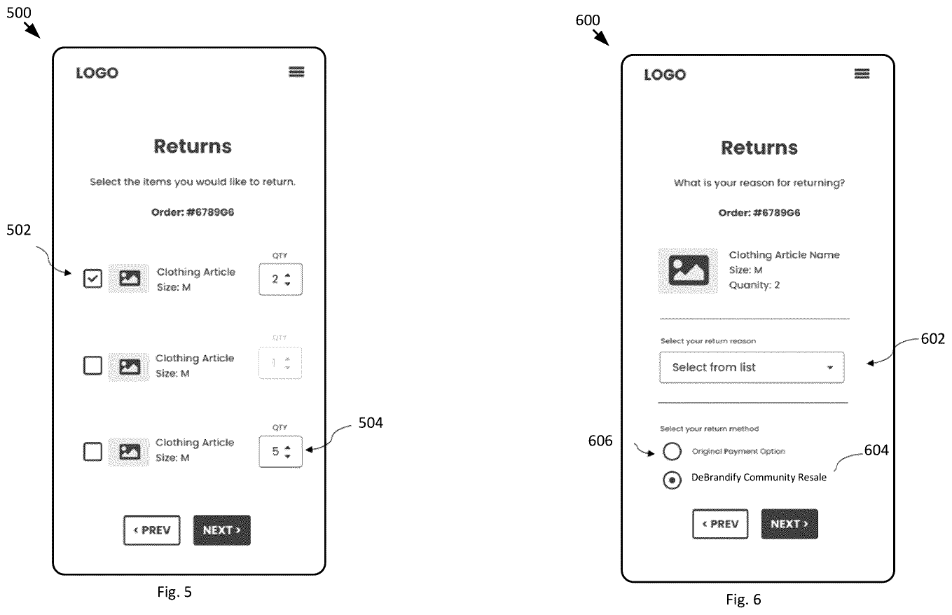

FIGS. 5, 6, 7 and 8 show interfaces for a customer (buyer A) to initiate a return. To select a product instance to return, an interface is provided to buyer A to receive an order number and identification information associated with the order such as an email address. Though not shown, two factor authentication can be used to authenticate buyer A. Associated order information is available from the e-commerce transaction between buyer A and merchant and, in an embodiment, is stored in an order record of an order database (not shown) operated by merchant online store 230. As shown in FIG. 5, an interface 500 presents order information obtained from the order database of the online store 240 of the marketplace platform. Interface 500 provides a listing or other presentation of purchased products from the order. In an embodiment, buyer A is enabled to select (e.g. 502) one or more specific products and, as applicable, product quantities (504) to return.

FIG. 6 shows an interface 600 to complete additional return information (e.g. 602), providing an option 604 to return via the marketplace or an option 606 to return via regular return channel. Selecting option 604 triggers operations of the marketplace platform to make the instance of the product available via returns marketplace 240. In an embodiment, a return reason may prevent return via the marketplace platform (e.g. excessive damage). The marketplace platform, in an embodiment, initiates a return record (e.g. 230C) for buyer A and the returned product. Data from the return record can be used to offer the instance of the product to buyer B, among others.

In accordance with an embodiment such as where two return options are available, in the case of a return request with at least one item that qualifies for marketplace return and at least one item for regular returns only, all shipping labels are held for a maximum period to accommodate a sale through the returns marketplace (e.g. 48 hrs) before being sent to buyer A. If one or more of the marketplace returned items do not re-sell via the marketplace, these items are included in the regular return channel and are included in the shipping of such items. If one or more marketplace returned items are sold, buyer A receives appropriate labels for the various resale(s) and regular return.

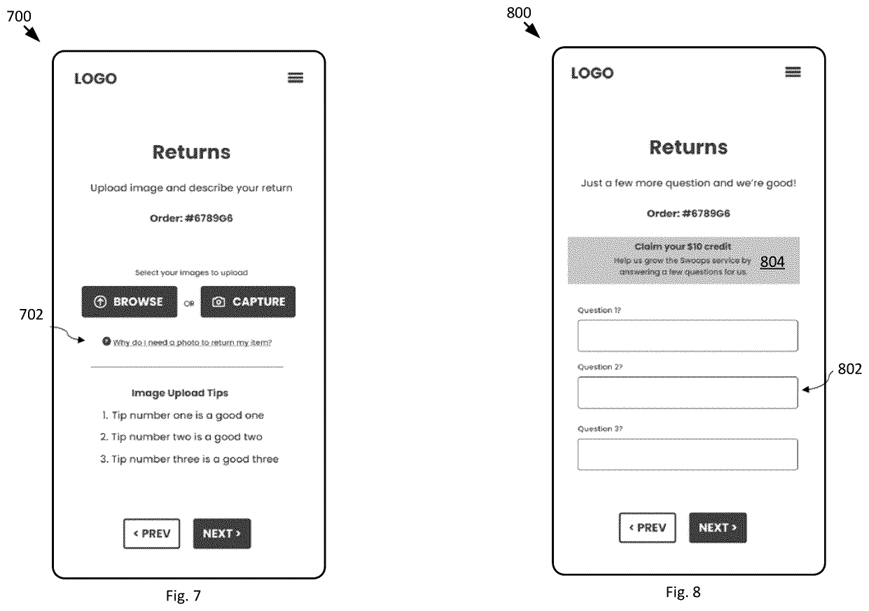

FIG. 7 shows an interface 700 to obtain details of the product (e.g. an image upload 702) for the return record. FIG. 8 shows an interface 800 to obtain further details of the product. Interface 800 has controls (e.g. 702) seeking information about the product such as whether the returned product matches the merchant's photos, the merchant description, the condition (new or not) and brand recommendation. At 804 an incentive to complete survey questions is offered.

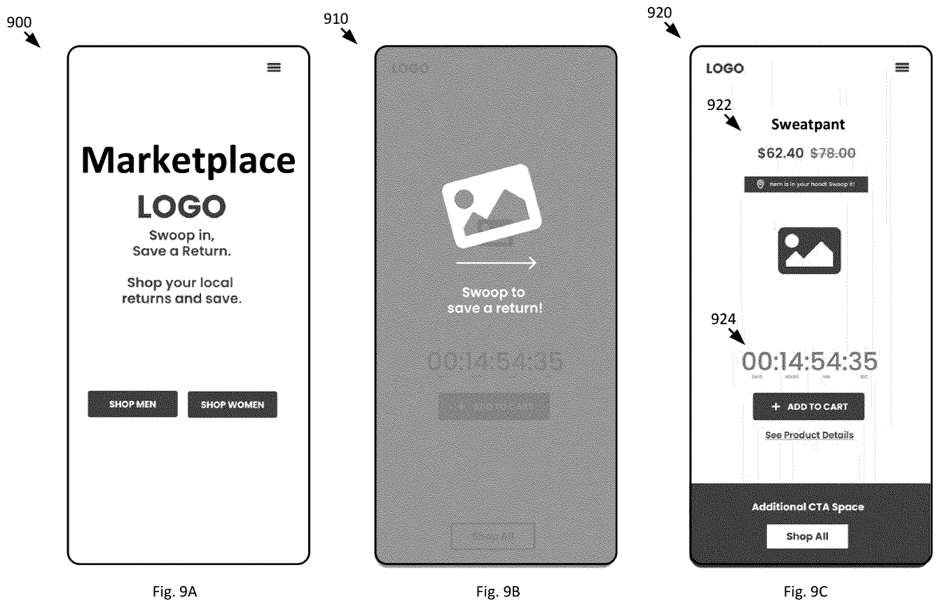

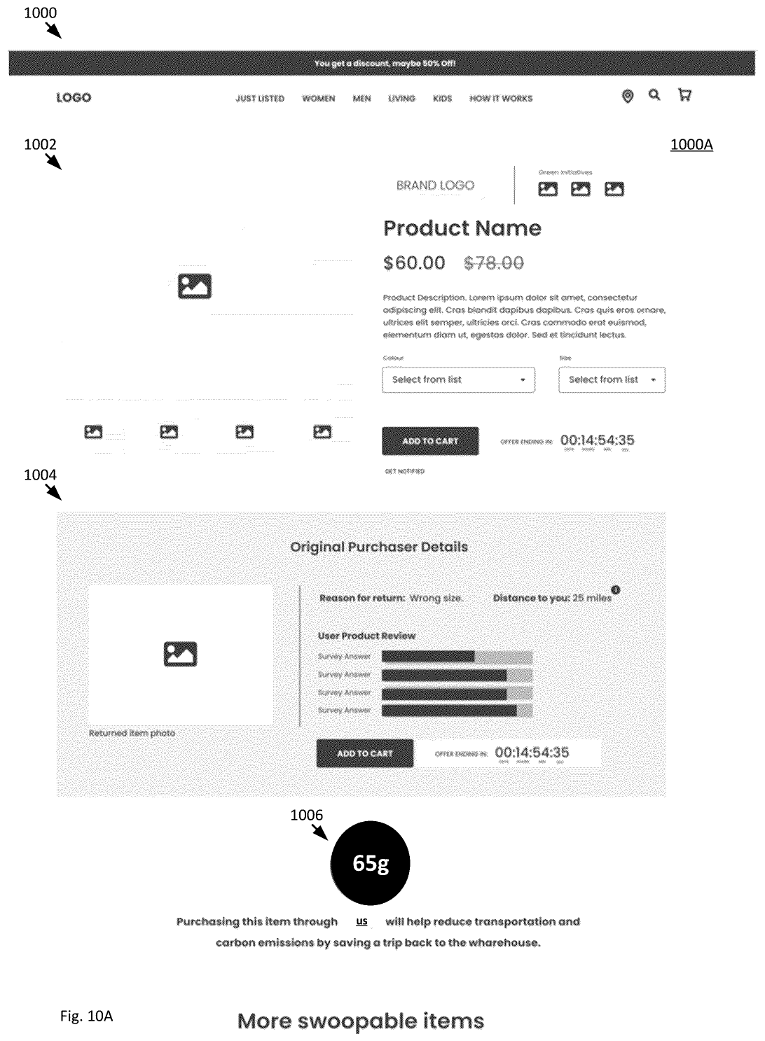

FIGS. 9A, 9B and 9C show interfaces 900, 910 and 920 for a marketplace application for online buyers, for example, buyer B or Buyer C, to locate and purchase returned items. FIG. 9C shows one located item 922 within the geographic search area of buyer B. In accordance with an embodiment, the interface shows a time-limited availability (e.g. timer display 924) associated with the located item. The timer display can be updated in real-time, for example. In an embodiment, each item listed on the marketplace is associated with a respective time-limited availability that measures from the time of listing. In an embodiment the maximum time-limited availability is 48 hours from the time of listing. In an embodiment, products of a first category can have a maximum time-limited availability (e.g. 72 hours) that differs from products of a second category (48 hours), and that differs from products of a third category (60 hours), etc. In an embodiment, the discount (e.g., a price difference to original price) can be increased closer to the end of the sale period.

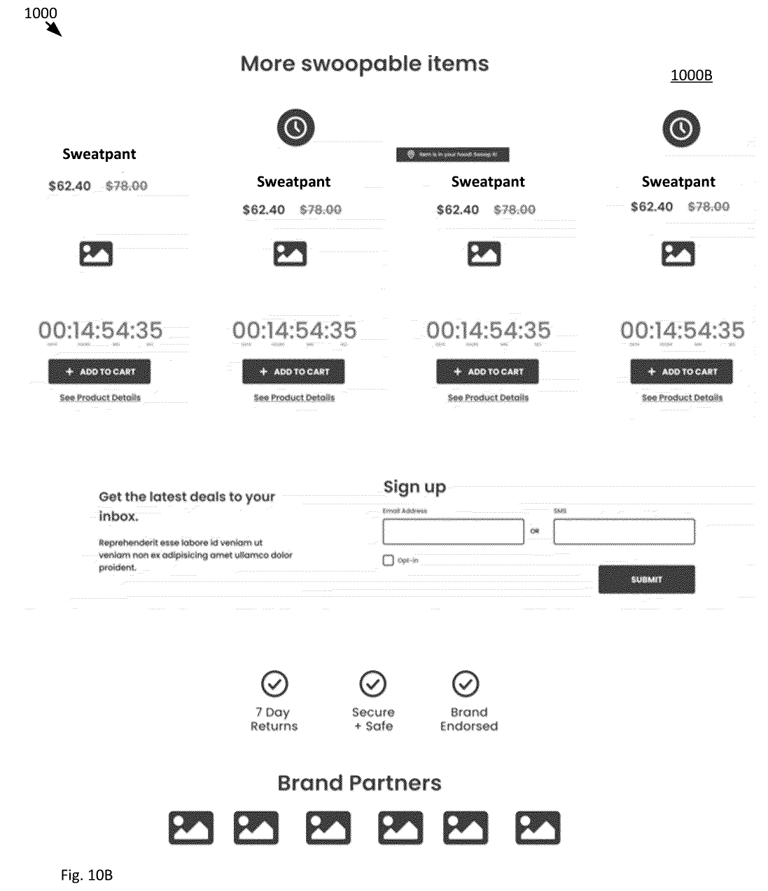

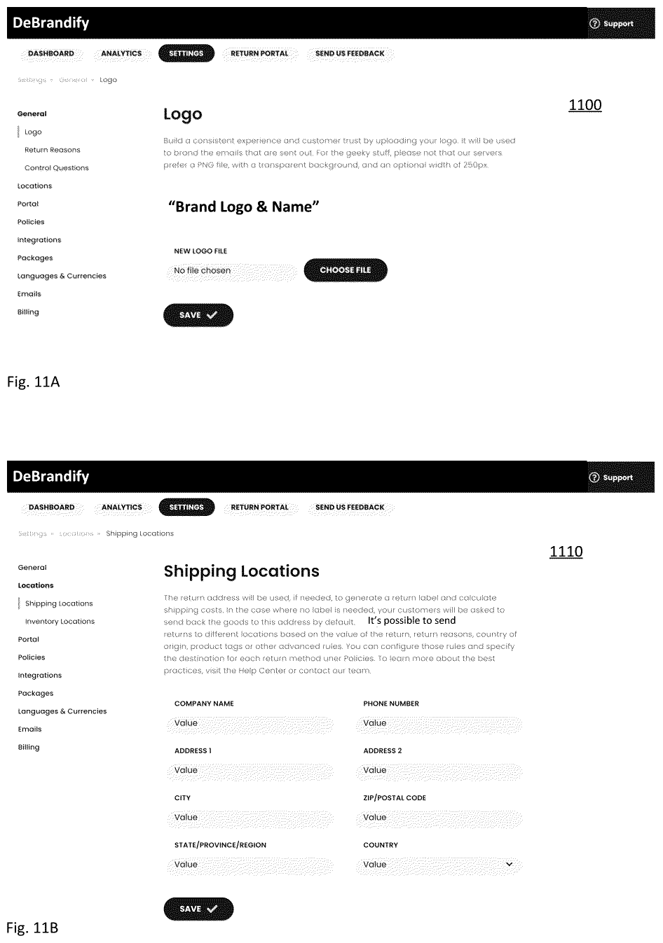

FIGS. 10A and 10B show interface 1000 comprising components 1000A and 1000B in accordance with an embodiment that lists an instance of a return product (1000A) and other product returns (1000B). Interface 1000 can be viewed such as by scrolling the interface components 1000A and 1000B in a viewing window of a display device. Interface 1000A shows merchant product information at 1002 and customer generated product information at 1004. At 1006 there is shown carbon emission data representing a reduction in greenhouse gases through the purchase from the return marketplace.

Platform 200 provides a merchant interface (e.g. a web-based interface) to provide and receive information regarding returns via the marketplace 240. Merchant related information for settings comprises merchant logo, return reasons, control questions, merchant locations (shipping locations for returns and inventory locations for restocking), portal, policies, integrations, packages, language and currencies, emails, and billing information. In an example, merchant location can have two inventory locations within the same facility. Returns could be directed to one or the other location within the same warehouse. In an example, portal refers to the platform interface installed on the merchant's website that allows them to access platform services, integrations refers to third party integrations with shipping and payment partners and packages refers to shipping/logistics aspects. Setting information automates the returns process and reduces manual involvement.

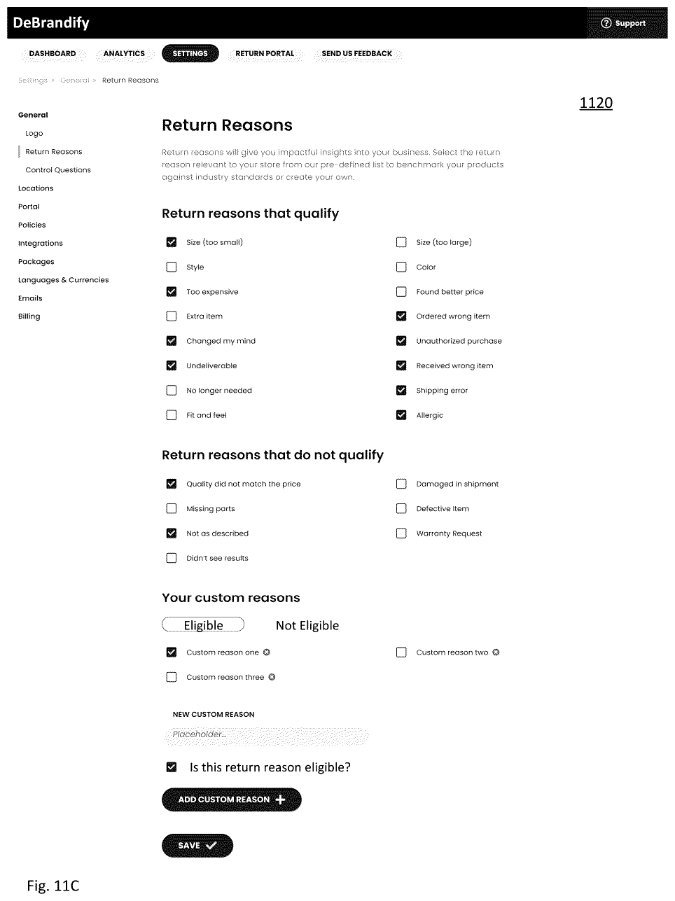

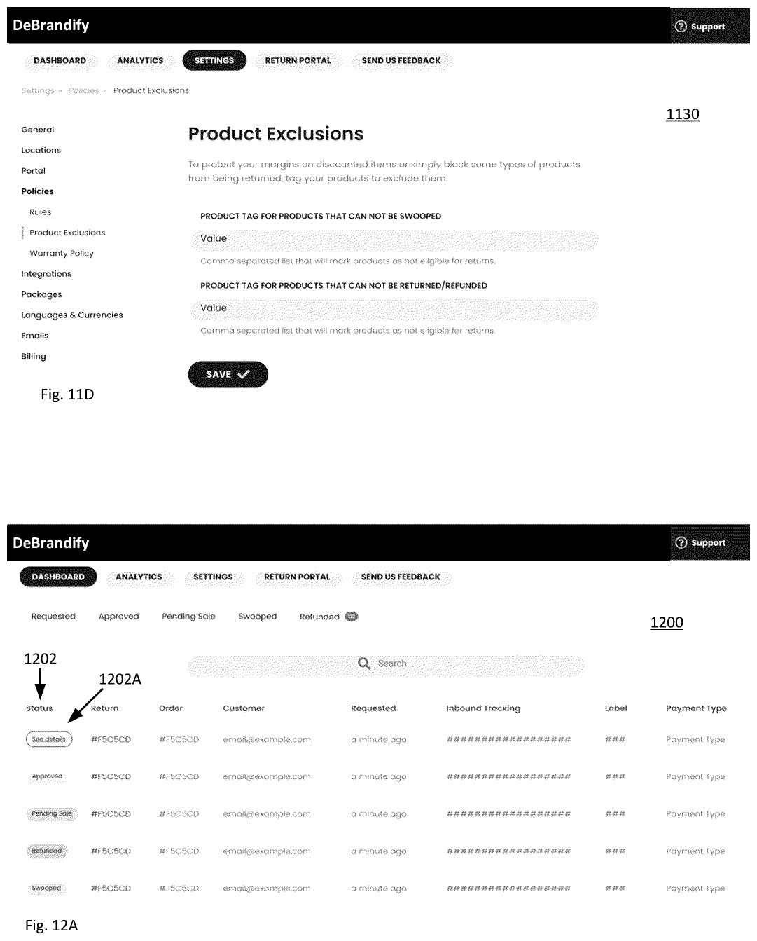

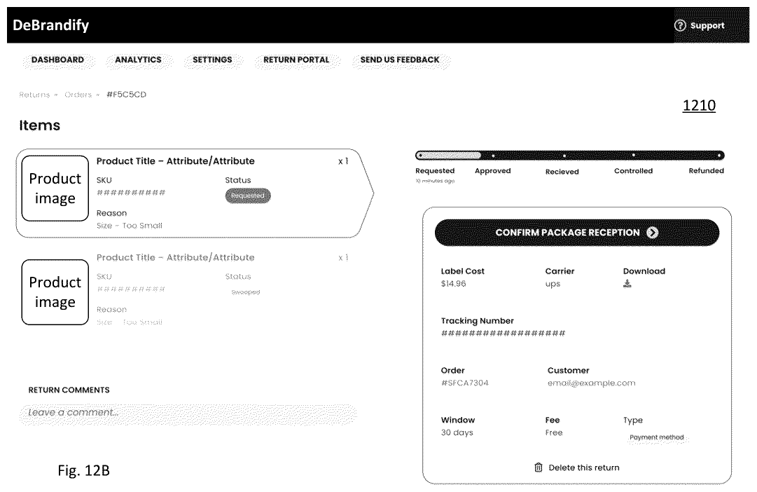

FIGS. 11A, 11B, 11C, 11D show interfaces 1100, 1110, 1120 and 1130 for display via a merchant device (e.g. 206 or 208). Interfaces 1100, 1110, 1120 and 1130 relate to inputting settings information for returns marketplace 240 and the return management engine 250. Interface 1100 relates to brand logo information. Interface 1110 relates to shipping locations. Interface 1120 relates to return reasons and interface 1130 relates to product exclusions. Examples of return eligibility criteria include product price, product type and return reason. Policies, rules and/or exclusions can be configured for such criteria.

Further, the merchant interface includes features to allow the merchant to manage returns, that is manage a customer's initial order having one or more return items. The merchant app also allows the merchant to track and edit the status of each return item for a customer order as well as access analytics and other features. In an embodiment where platform 202 manages both types of returns for a merchant—regular returns and resale returns, each return type is processed in respective stages. For example, a successful regular return of an item initiates with a request for return, is approved (e.g. using merchant settings), is received via return shipping, is controlled (regarding inventory control) and is refunded (payment to buyer A). In an embodiment, a regular return can trigger the merchant interface to present controls to enable a merchant to provide restocking information to identify an inventory location to restock. The Interface can trigger in response to a received status.

For a platform resale, a successful resale return of an item initiates with a request for return, is approved (e.g. using merchant settings and platform settings), is pending sale while listed on the platform (e.g. up to a maximum time or until sold), is sold and is refunded. If a resale return is not sold within its time limit, it is returned to the merchant and refunded. In an embodiment, a receipt of the unsold item by the merchant can trigger the merchant interface to present controls to enable a merchant to provide restocking information to identify an inventory location to restock.

As noted, a customer's respective order may have a regular return item and a resale return item. The merchant interface for the respective order can present options for each item by return type.

Once all returns for a respective orders are completed, the order can be archived.

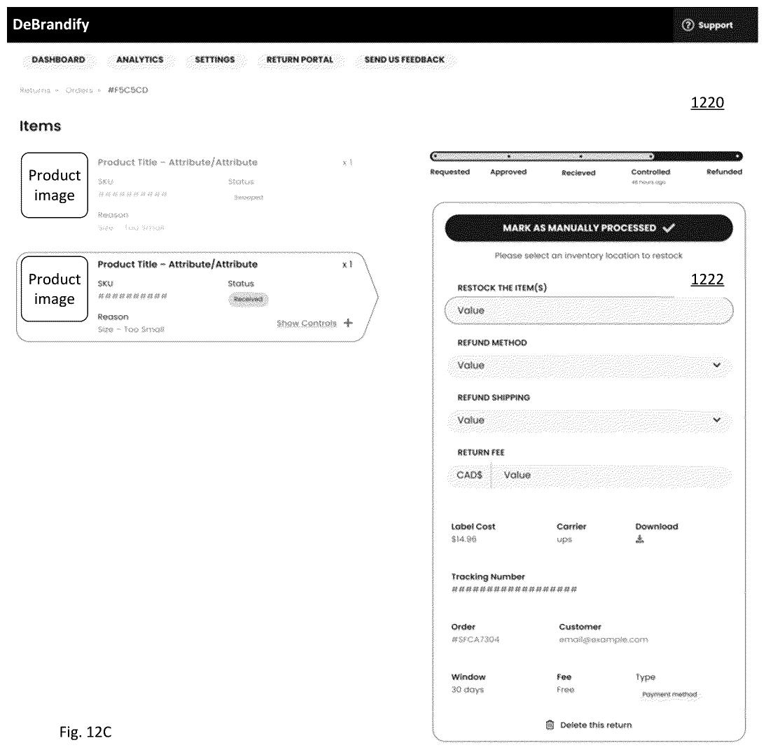

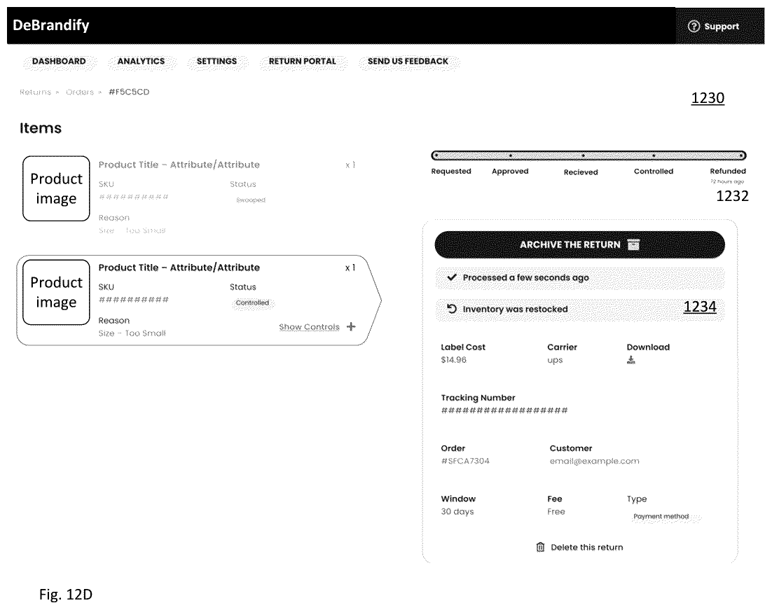

FIGS. 12A, 12B, 12C, 12D show interfaces 1200, 1210, 1220 and 1230 for display via a merchant device (e.g. 206 or 208). Interfaces 1200, 1210, 1220 and 1230 relate to features to allow the merchant to manage returns. Interface 1200 shows a dashboard providing an overview of items by status (1202) within the platform. 1202A relates to a customer order having more than one return item. Clicking through status control 1202A invokes interface 1200 to show further details for each a particular item.

Interface 1220 shows an item in the regular return stream with a received status and being processed via an interface control to perform inventory control. Interface 1230 shows status after the return is completed, showing that the order from buyer A was refunded 1232 and the item was restocked 1234 to merchant's inventory. Regular returns and returns via the marketplace can have different status timelines reflecting the two return processes.

It will be apparent that the various embodiments show methods and systems to address the environmental impacts related to e-commerce returns. The methods and systems assist to:
Reduce product waste: research shows that a large portion of returned products are destroyed and wasted because merchants accrue higher costs from processing and restocking returned products than destroying the products.
Reduce packaging waste: shipping products directly from customer A to customer B reduces the amount of new packaging needed when compared to the option of shipping the product back to the merchant's warehouse and shipping the same/new product to customer B in new packaging, such as when a merchant's warehouse personnel open, inspect, and repackage the product in new packaging.
Reduce carbon emissions: shipping products directly from customer A to customer B can reduce shipping distances. By limiting the product availability/visibility on the marketplace website to buying customers (e.g. customer B) who are in the vicinity of the customer A and shipping the product directly from customer A to customer B, the shipping distance is ideally lower than shipping the product back from customer A to the merchant's warehouse and then to customer B. Cutting out a second shipment and limit distances of the only shipment can minimize the carbon footprint of the return shipment. A third party operated carbon calculator, in an embodiment, determines the carbon emissions for each shipment compared to a worst-case scenario.

The following are examples of features, in accordance with embodiments, that the platform can provide. In an embodiment, resales that are limited time offers are used to ensure timely refund to first purchasing customer (returnee) (48-72 hour sale window, “flash sale”). As soon as the item is sold, the sale closes. In an embodiment, the resale platform integrates return services for merchants. Product approval and posting/listing on the resale platform is automated (e.g. via policy and rules based selection logic) and does not require the merchant's manual involvement. Merchants define the product eligibility logic in the merchant portal (policies). In an embodiment, eligibility logic may include: order type (is order within return window?), product type (are products eligible to be posted on returns marketplace, e.g., could be product category/type or product value-based logic), and return reason (e.g., defected/damaged items must be returned to merchant, products must be in sellable condition).

In an embodiment, product offering to buyer B visiting the returns marketplace website will depend on the customer's location in relation to the returnee to minimize return shipping distances. Buyer B could, for example, only be shown products within a radius of x km (y miles) from their location, where x (y) are set values by the marketplace and/or customizable values (for example, within a defined range of options) by each customer. In an embodiment, product offerings may also be customized based on buyer B's set preferences. For example, in addition to location preferences, a customer may set filters for product type, product size, gender, price, discount amount, return reason, product condition, brand, freshness of listing (e.g. only listed within most recent N hours), etc.

In an embodiment, savings in shipping distances are calculated based on the buyer A's and buyer B's location and the merchant's warehouse location to determine whether shipping from buyer A to buyer B results in a reduction in shipping distance and consequently, in reduction of carbon emissions. The reduction of carbon emissions is displayed on the product page to buyer B to advise them of the environmental benefits of using returns marketplace.

In an embodiment, the platform is configured to enable a merchant's customers to sell products that are no longer eligible for brand return (e.g., the return window has expired, final sale products). Similarly to listing resale returns in accordance with the teaching herein, a listing for a non-return peer-to-peer sale can be defined. The non-return listing comprises, in an embodiment, product data retrieved from the merchant's product database, such as described for return listings. The selling customer can also upload picture, answer survey and provide condition information. Transactions would happen between two customers but be “brand endorsed”. Brands could set pricing rules for products sold through the non-return peer-to-peer mechanism, such as through the merchant settings interface. The non-return sale listing can be similar to a return sale listing. That is, in an embodiment, the non-return sale listing is any of: time-limited from the time of the listing, presented to potential buyers based on location, is associated with and displays carbon emission savings for each potential buyer based on, for example, a location difference between buyer A and buyer B, and merchant fulfillment centre and buyer B.

In an embodiment, there is provided an option for a merchant to integrate a returns marketplace control (e.g. a button or other control construct) on the merchant's online store (e.g. e-commerce site) to communicate with customers if the same product is available through the returns marketplace. In an embodiment, the control comprises or is otherwise associated with a link to the returns marketplace, for example, to the product listing or to a search interface with product information populated to perform a search for the product on the returns marketplace.

In an embodiment, in addition to computing device aspects, a person of ordinary skill will understand that computer program product aspects are disclosed, where instructions are stored in a non-transient storage device (e.g. a memory, CD-ROM, DVD-ROM, disc, etc.) that when executed cause a computing device to perform any of the method aspects disclosed herein. In an embodiment, a computing device comprises a processor (e.g. a microprocessor (e.g. a CPU, a GPU, a plurality of any of same), microcontroller, etc.) that executes computer readable instructions such as those stored in the storage device. In an embodiment, the computing device comprises (for example “purpose built”) circuitry that executes the functions of the instructions, for example, without the need to read such instructions. In an embodiment, a computing device can further comprise user interface components such as one or more of a display screen (which may be touch enabled (e.g. for gestural input)), a keyboard, a pointing device, a speaker, a microphone, a camera, a printer, a scanner and other input, output or input/output devices. In an embodiment, a computing device can further comprise, a GPS device, a network interface (whether wired or wireless), a near field communication (NFC) device, etc.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

1. A method comprising:
providing a returns marketplace for conducting e-commerce transactions to resell return items sold by a merchant to customers, the returns marketplace comprising an interface to:
store a product listing for a return item purchased from the merchant by a first buyer (buyer A);
present the product listing to a second buyer (buyer B), the product listing selected for presenting in response to a relative location of buyer A and buyer B; and
arranging delivery of the return item to buyer B from buyer A, in response to an e-commerce transaction concluded with buyer B to purchase the return item;
wherein the delivery of the return item to buyer B avoids a delivery from buyer A to a return location of the merchant to reduce an overall environmental impact of product returns.

2. The method of claim 1, wherein the delivery of the return item to buyer B avoids any of: repackaging of the return item for resale; restocking of the return item for resale; destruction of the return item.

3. The method of claim 1 comprising determining a carbon emission savings associated with the delivery of the return item to buyer B and including the carbon emission savings in the product listing to entice buyer B to conclude the e-commerce transaction and achieve the carbon emission savings.

4. The method of claim 1 comprising: associating the product listing with a time limit within which to conclude the e-commerce transaction, the time limit associated with a time of listing the return item for resale; wherein the product listing is presented only if the time limit is not expired.

5. The method of claim 4 comprising arranging delivery of the return item from buyer A to the return location of the merchant if the return item is not sold within the time limit.

6. The method of claim 4, wherein:
buyer A has purchased an additional return item from the merchant, the additional return item for return to the merchant without offering resale via the returns marketplace; and
the method comprises arranging delivery of the additional return item to the merchant.

7. The method of claim 6, wherein delivery of the additional return item to the merchant is combined with delivery of any of buyer A's return items listed but unsold via the returns marketplace.

8. The method of claim 1 comprising determining the eligibility of the return item for resale via the return marketplace in accordance with one or more return criteria of the merchant.

9. The method of claim 8, wherein the returns marketplace comprises an interface for an ineligible return item purchased from the merchant by a merchant purchaser, the interface for the ineligible return item configured to:
store an ineligible return item product listing for the ineligible return item for a peer-to peer sale;
present the ineligible return item product listing to a marketplace buyer, the product listing selected for presenting in response to a location of the marketplace buyer relative to a location of the merchant purchaser; and
arrange delivery of the return item to the marketplace buyer from the merchant purchaser from, in response to an e-commerce transaction concluded with the marketplace buyer to purchase the return item.

10. The method of claim 9, wherein the ineligible return item product listing is defined, at least in part, using: any one or more of i) ineligible return item criteria of the merchant, and ii) product information obtained from the merchant, thereby to define a brand endorsed ineligible return item product listing.

11. The method of claim 1, wherein the product listing for the return item is defined, at least in part, using return product listing criteria of the merchant.

12. The method of claim 1, wherein the returns marketplace is provided via an e-commerce platform integrated with a merchant online store selling the return items to customers to provide an integrated service to the merchant.

13. The method of claim 1, wherein the returns marketplace is provided via a control comprising a button or other graphical element on a merchant online store or other website, the control linking to an e-commerce platform that is separate from the merchant online store or other website.

14. The method of claim 1, wherein the returns marketplace is configured to accept a second return of the return item, the second return initiated by buyer B, the second return presenting the product listing of the return item of buyer B to a Buyer C for a second resale, the presenting responsive to a relative location of buyer B and Buyer C.

15. The method of claim 1, wherein relative location is determined by any one of:
a threshold distance of the retail marketplace;
a profile setting of a potential return item buyer to receive a presentation of selected product listings; or
a minimum carbon emission savings determined for a resale transaction that delivers the return item from one buyer to another avoiding a delivery to the merchant.

16. The method of claim 1 comprising:
concluding an e-commerce transaction with buyer B to purchase the return item; and
arranging delivery of the return item to buyer B from buyer A to avoid a delivery from buyer A to the return location of the merchant.

17. A computing device comprising a processor and a non-transitory storage device, the storage device storing computer-readable instructions that, when executed by the processor, cause the computing device to:
provide a returns marketplace for conducting e-commerce transactions to resell return items sold by a merchant to customers, the returns marketplace comprising an interface to:
store a product listing for a return item purchased from the merchant by a first buyer (buyer A);
present the product listing to a second buyer (buyer B), the product listing selected for presenting in response to a relative location of buyer A and buyer B; and
arranging delivery of the return item to buyer B from buyer A, in response to an e-commerce transaction concluded with buyer B to purchase the return item;
wherein the delivery of the return item to buyer B avoids a delivery from buyer A to a return location of the merchant to reduce an overall environmental impact of product returns.

18. The computing device of claim 17, wherein the instructions are executable to configure the computing device to:
associate the product listing with a time limit within which to conclude the e-commerce transaction, the time limit associated with a time of listing the return item for resale; wherein the product listing is presented only if the time limit is not expired; and
arrange delivery of the return item from buyer A to the return location of the merchant if the return item is not sold within the time limit.

19. A non-transitory storage device storing computer-readable instructions that, when executed by a processor of a computing device, cause the computing device to perform a method comprising:
providing a returns marketplace for conducting e-commerce transactions to resell return items sold by a merchant to customers, the returns marketplace comprising an interface to:
store a product listing for a return item purchased from the merchant by a first buyer (buyer A);
present the product listing to a second buyer (buyer B), the product listing selected for presenting in response to a relative location of buyer A and buyer B; and
arranging delivery of the return item to buyer B from buyer A, in response to an e-commerce transaction concluded with buyer B to purchase the return item;
wherein the delivery of the return item to buyer B avoids a delivery from buyer A to a return location of the merchant to reduce an overall environmental impact of product returns.

20. The non-transitory storage device of claim 19, wherein the method comprises one or both of:
determining the eligibility of the return item for resale via the return marketplace in accordance with one or more return criteria of the merchant; and provide an ineligible returns interface for an ineligible return item purchased from the merchant by a merchant purchaser, the interface for the ineligible return item configured to:
store an ineligible return item product listing for the ineligible return item for a peer-to peer sale;
present the ineligible return item product listing to a marketplace buyer, the product listing selected for presenting in response to a location of the marketplace buyer relative to a location of the merchant purchaser; and
arrange delivery of the return item to the marketplace buyer from the merchant purchaser from, in response to an e-commerce transaction concluded with the marketplace buyer to purchase the return item.
